(19) United States
(12) Patent Application Publication
(10) Pub. No.: US 2011/0135081 A1
(43) Pub. Date: Jun. 9, 2011

(54) METHODS TO IMPROVE FRAUD DETECTION ON CONFERENCE CALLING SYSTEMS BY DETECTION OF NON-TYPICAL USEAGE OF MODERATOR PASSCODE

(76) Inventors: Charles Steven Lingafelt, Durham, NC (US); James William Murray, Research Triangle Park, NC (US); James Thomas Swantek, Canton, GA (US)

(21) Appl. No.: 12/631,425

(22) Filed: Dec. 4, 2009

(51) Int. Cl. H04M 3/42

(52) U.S. Cl. 379/203.01; 379/207.11

(57) ABSTRACT

An embodiment of the invention includes a method for detecting fraudulent use in a conference calling system. One or more access parameters are received, wherein the access parameters include an authorized day of week parameter, an authorized time of day parameter, and/or an authorized location parameter. One or more requests to access the conference calling system are received, wherein each request includes a user passcode and one or more request parameters. A processor determines whether the request parameters match the access parameters. Access to the conference calling system is granted when the request parameters match the access parameters; however, the processor performs actions when a request parameter does not match an access parameter.

### BACKGROUND

The present invention is in the field of methods, systems, and computer program products to improve fraud detection on conference calling systems by detection of non-typical usage of moderator passcodes.

A conference call (also known as a “teleconference” or a “teleconference call”) is a telephone call in which the calling party wishes to have more than one called party participate in the audio portion of the call. The conference call may be designed to allow the called party to participate during the call, or the call may be set up so that the called party merely listens into the call and cannot speak. It is often referred to as an ATC (Audio Tele-Conference). In addition to audio, conference calls can include video, multimedia and other communication methods.

Conference calls can be designed so that the calling party calls the other participants and adds them to the call; however, participants are usually able to call into the conference call without assistance from an “operator” of the conference system, by dialing into a special telephone number that connects to a “conference bridge” (a specialized type of equipment that links telephone lines).

Companies commonly use a specialized service provider who maintains the conference bridge, or who provides the phone numbers and PIN codes that participants dial to access the meeting or conference call.

### SUMMARY

An embodiment of the invention includes a method for detecting fraudulent use in a conference calling system. One or more access parameters (also referred to herein as “typical usage parameters”) are received, wherein the access parameters include an authorized day of week parameter, an authorized time of day parameter, and/or an authorized location parameter. The authorized day of week parameter indicates at least one day of the week where access to the conference calling system is authorized. The authorized time of day parameter indicates at least one time of day where access to the conference calling system is authorized; and, the authorized location parameter indicates at least one location where access to the conference calling system is authorized.

One or more requests to access the conference calling system are received, wherein each request includes a user passcode and one or more request parameters. The request parameters include a request day of week parameter indicating the day of the week that the request is received, a request time of day parameter indicating the time of day that the request is received, and/or a request location parameter indicating the location where the request is sent from.

A processor determines whether the request parameters match the access parameters. Access to the conference calling system is granted when the request parameters match the access parameters; however, the processor performs actions when a request parameter does not match an access parameter. In at least one embodiment, the actions include sending an alert indicating that a request parameter does not match an access parameter to an administrator of the conference calling system, the person who sent the request to access the conference calling system, participants of the conference call of the conference calling system, and/or at least one security personnel.

At least one embodiment of the invention, user information is obtained from the person assigned the user passcode violating the access parameter. The user information includes an employee number, an identification badge number, a home a telephone number, a home address, a mobile telephone number, an e-mail address, an office telephone number, an office address, and/or answer(s) to security question(s) entered by the person assigned the user passcode. In such an embodiment, the actions performed by the processor include obtaining validation information from the person who sent the request violating the access parameter, and determining whether the validation information matches the user information. If the user information matches the validation information, an alert indicating that the request parameter does not match the access parameter is sent to the person who sent the request to access the conference calling system.

In at least one embodiment of the invention, the actions further include permitting an administrator of the conference calling system to enter the conference call, terminating the conference call, and/or voiding the user passcode. In another embodiment, the actions include generating and storing a report, where the report includes the user passcode violating the access parameter, the violated access parameter, the request parameter violating the access parameter, and/or the actions performed (e.g., including the user and validation information).

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 illustrates a conference calling system according to embodiment of the invention;

FIG. 2 is a flow diagram illustrating a preparation phase according to an embodiment of the invention;

FIG. 3 is a flow diagram illustrating a method for determining non-typical usage of a passcode according to an embodiment of the invention;

FIG. 4 is a flow diagram illustrating a method for performing response actions according to an embodiment of the invention;

FIG. 5 is a flow diagram illustrating a method for detecting fraudulent use of a passcode in a conference calling system according to an embodiment of the invention;

FIG. 6 illustrates a system for detecting fraudulent use of a passcode in a conference calling system according to an embodiment of the invention; and

FIG. 7 illustrates a computer program product according to an embodiment of the invention.

### DETAILED DESCRIPTION

Exemplary, non-limiting embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

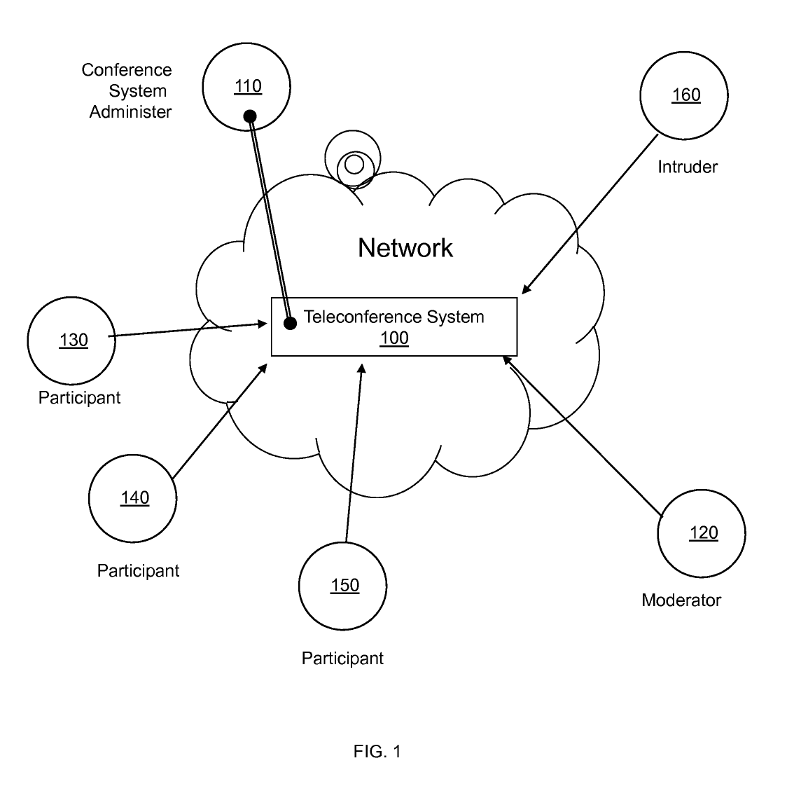

FIG. 1 illustrates a conference calling system (also known as a teleconference system) 100 according to embodiment of the invention, wherein a conference system administrator 110, conference moderator 120, participants 130, 140, and 150, and unauthorized intruder 160 are connected to the conference calling system 100. The conference moderator 120, participants 130, 140, and 150, and unauthorized intruder 160 are attendees of the conference calling system 100. In another embodiment, less than or more than three participants are connected to the conference calling system 100.

In order to connect to the conference calling system 100, the participants 130, 140, and 150 use a reservationless bridge. The bridge setup is dynamic, wherein a call-in telephone number and a passcode from the conference moderator 120 are sufficient to begin the conference call. The participants 130, 140, and 150 have the same passcode (i.e., Passcode A), which is different from the passcode of the conference moderator 120 (i.e., Passcode Z). In another embodiment of the invention, the participants 130, 140, and 150 have different passcodes (e.g., Passcodes A, B, and C, respectively). In one embodiment, the intruder 160 has the conference moderator 120's passcode (i.e., Passcode Z). In another embodiment, the intruder 160 utilizes a participant's passcode (i.e., Passcode A, B, or C, depending on how passcodes are assigned) to connect to the conference calling system 100.

The conference system administer 110 configures the conference calling system 100 and assures its operation. These functions are embodied in the provider of the conference calling system 100 (not shown). However, in one embodiment, these functions are delegated to the purchaser of the conference calling system 100. In another embodiment, an automatic monitoring system is utilized to configure the conference calling system 100 and assures its operation.

Having the conference moderator 120's passcode, the intruder 160 can either enter a conference call as an attendee during a legitimate meeting; or, the intruder 160 can establish an illegitimate meeting between himself and other intruders. In the fraud scenario illustrated in FIG. 1, the conference call was already in-process when the conference moderator 120 connected to the conference calling system 100. Without the fraud detection methodologies and systems herein, the conference calling system 100 does not inform the conference moderator 120 that another individual had previously started the conference call. Thus, the conference moderator 120 is not aware of the fraud by the intruder 160.

In one example of fraud, the intruder 160 connects to the conference calling system and waits until a conference call begins. This allows the intruder 160 to obtain information during the conference call. The intruder 160 is also allowed to use the conference calling system for other purposes after the moderator 120 and participants 130-150 disconnect from the conference calling system, for example, holding another conference call by sharing the moderator passcode with others.

In another example of fraud, the conference moderator 120's passcode is entered outside of pre-defined parameters in the conferencing service setup, as more fully described below. An embodiment of the invention prevents the initial act of fraud by establishing pre-registration typical access parameters and additional validations that ensures only the authorized moderator is able to initiate the conference call.

An embodiment of the invention includes a preparation phase for defining indicators, which the conference calling system utilizes when a conference moderator's passcode is entered. Pre-registration of typical usage parameters is completed during the preparation phase by the conference moderator prior to the initiation of the conference call. The conference moderator is the attendee of the conference call that has the proper credentials to open the conference call. In another embodiment, the typical usage parameters are defined by another entity, such as, for example, the conference system administrator or the conference moderator's employer. In at least one embodiment of the invention, the preparation phase includes defining response actions, which will be performed by the conference calling system should the moderator passcode be entered during a non-typical parameter setting.

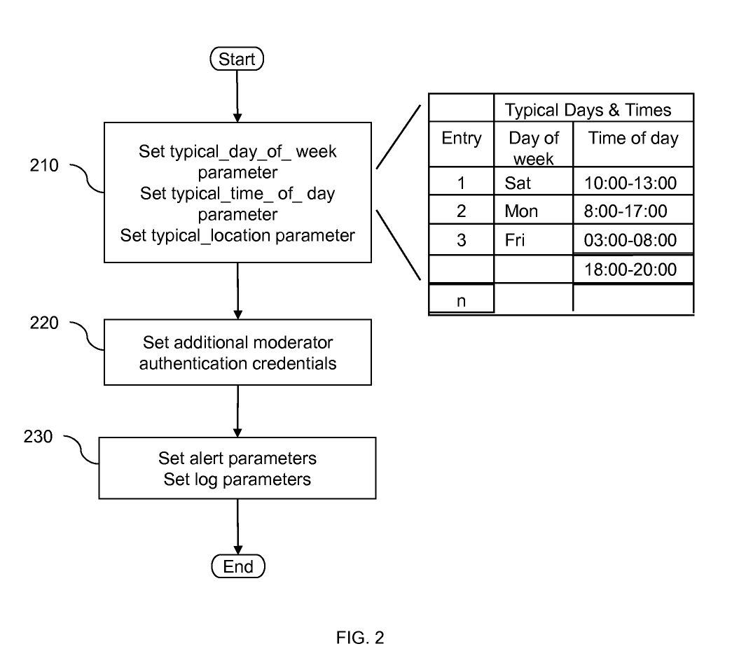

FIG. 2 is a flow diagram illustrating a preparation phase according to an embodiment of the invention. The conference moderator defines typical usage parameters (210) by calling the conference calling system and answering select configuration questions (e.g., via a telephone keypad) and/or configuration is completed via a website where the conference moderator enters typical usage parameters (e.g., via drop-down menus). In at least one embodiment, the typical usage parameters include the day of week parameter, the time of day parameter, and the location parameter (i.e., where the conference moderator initiates the conference call).

In at least one embodiment of the invention, the day of week parameter includes a pre-defined set of days within the week that the conference moderator would normally utilize the conference calling system. For example, in the embodiment illustrated in FIG. 2, the day of week parameter includes Monday, Friday, and Saturday. In another embodiment, the day of week parameter includes a particular calendar date, e.g., Jan. 2, 2010. In yet another embodiment, the day of week parameter includes a date range, e.g., Jan. 2, 2010-Jan. 4, 2010. In still yet another embodiment, the day of week parameter includes a days of week range, e.g., Monday-Wednesday.

In at least one embodiment, the time of day parameter includes a pre-defined set of times within the day that the conference moderator would normally utilize the conference calling system. There can be multiple time of day periods within a given day of the week. For instance, in the embodiment illustrated in FIG. 2, the time of day parameter includes 10:00-13:00 (on Saturdays), 8:00-17:00 (on Mondays), and 3:00-8:00 and 18:00-20:00 (on Fridays). In an alternative embodiment, the time of day parameter can define a time period (e.g., 8:00-9:00) that the conference moderator would normally utilize the conference calling system for any day of the week. In another alternative embodiment, the day of week and time of day parameters include inverse statements defining a day of the week and a time period during the day that the conference moderator would not typically utilize the conference calling system (also referred to herein as “unauthorized access parameters”). For example, the day of week parameter includes not Sunday; and the time of day parameter includes not 20:00-23:00.

In at least one embodiment, the location parameter includes a pre-defined set of locations where the conference moderator would normally call from to utilize the conference calling system. For example, the locations include a particular telephone number, office building, area code, zip code, address, city, state, and/or time zone where the conference call was initiated. In an alternative embodiment, the location parameter includes an inverse statement defining a location where the conference moderator would not typically initiate the conference call (also referred to herein as “unauthorized access parameters”). For example, the location parameter includes not the U.S. mountain time zone.

Additional moderator authentication credentials are also set during the preparation phase (220). In at least one embodiment, such credentials include the conference moderator's corporate employee number and company identification badge number, which are utilized to verify that the true moderator (i.e., the person assigned the moderator passcode) is attempting to access the conference calling system.

The preparation phase further includes setting alert parameters and log parameters (230). The alert parameters define response actions to be taken by the conference calling system should the moderator passcode be entered during a non-typical parameter setting. For example, if a moderator passcode is entered during a day of the week that does not match the day of week parameter, then an alert parameter triggers the sending of a time-stamped email to the conference system administrator.

The log parameters define response actions to be taken by the conference calling system should the moderator passcode be entered during a non-typical parameter setting. For example, if a moderator passcode is entered from a location that does not match the typical location parameter, then a log parameter triggers the generation of a report that includes the telephone number in which the moderator passcode was sent from.

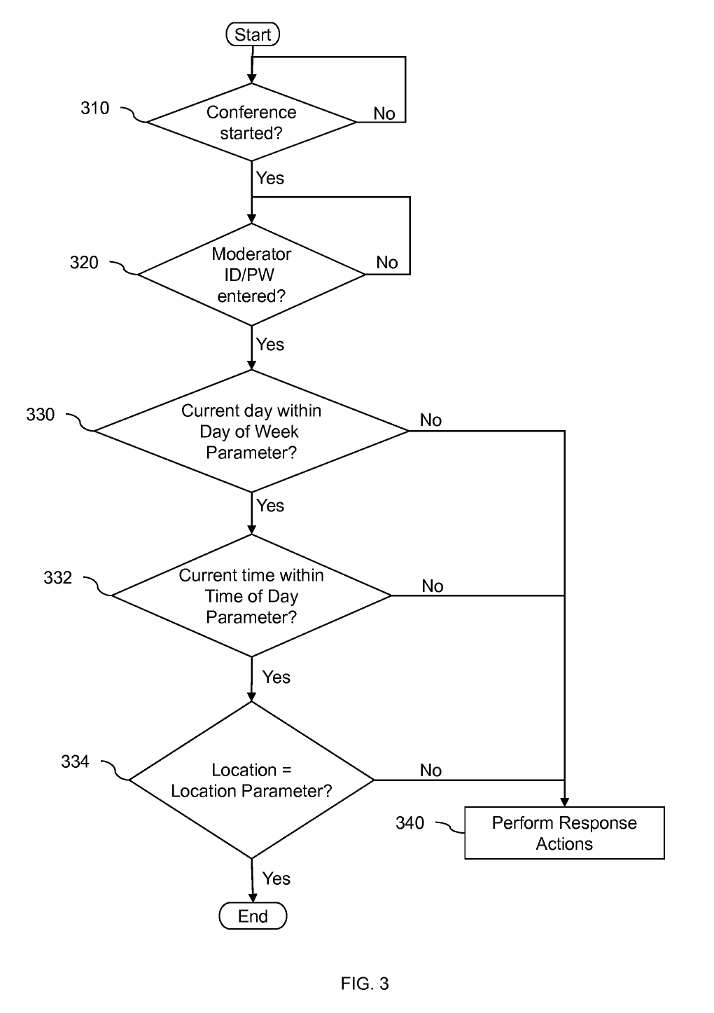

FIG. 3 is a flow diagram illustrating a method for determining non-typical usage of a moderator passcode according to an embodiment of the invention. The conference calling system determines whether the conference call has begun (310) and whether the moderator ID and/or passcode has been entered (320). If the moderator ID and/or passcode has been entered, the conference calling system validates the typical usage parameters that were defined in the preparation phase. In an alternative embodiment, however, the conference call begins after the moderator ID and/or passcode is entered and the typical usage parameters are validated.

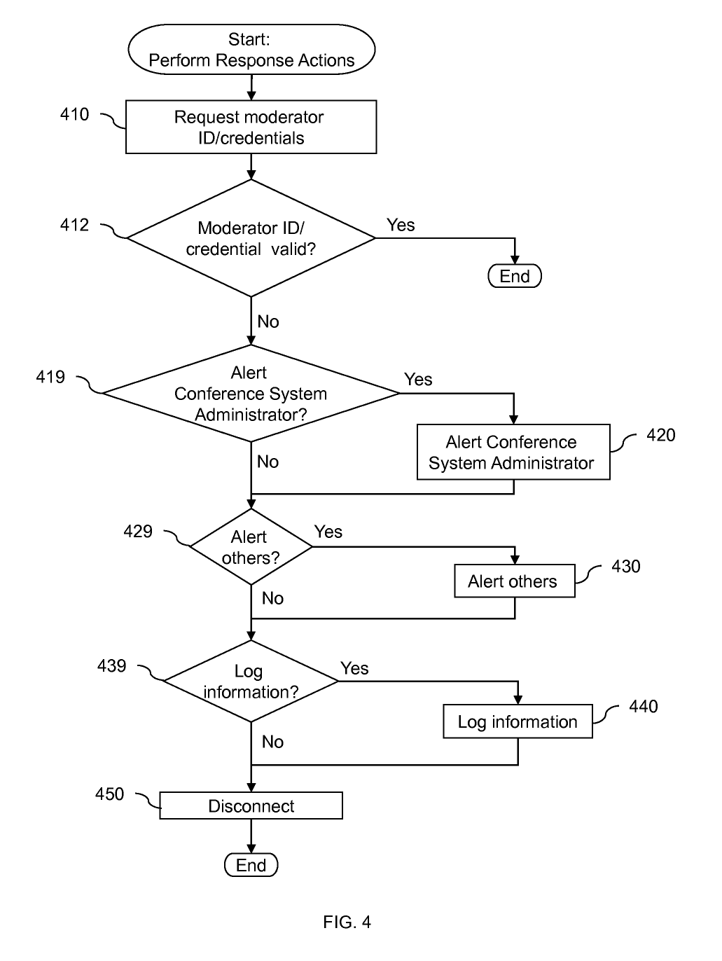

More specifically, the conference calling system determines whether the day of the week that the moderator ID and/or passcode was entered matches the day of week parameter (330). If the day of the week that the moderator ID and/or passcode was entered does not match the day of week parameter, the conference calling system performs response actions (340), as more fully described below with reference to FIG. 4. For example, if the moderator ID and/or passcode was entered on a Sunday, and the day of the week parameter only includes Monday, Tuesday, and Wednesday, then response actions are performed. In an alternative embodiment, the conference calling system determines whether the day of the week that a participant passcode was entered matches the day of week parameter.

If the day of the week that the moderator ID and/or passcode was entered matches the day of week parameter, the conference calling system determines whether the time of day that the moderator ID and/or passcode was entered matches the time of day parameter (332). If the time of day that the moderator ID and/or passcode was entered does not match the time of day parameter, the conference calling system performs response actions (340). For example, if the moderator ID and/or passcode was entered at 12:00, and the day of the week parameter only includes 8:00-11:00 and 13:00-17:00, then response actions are performed. In an alternative embodiment, the conference calling system determines whether the time of day that a participant passcode was entered matches the time of day parameter.

If the time of day that the moderator ID and/or passcode was entered matches the time of day parameter, the conference calling system determines whether the location where the moderator ID and/or passcode was entered matches the location parameter (334). If the location where the moderator ID and/or passcode was entered does not match the location parameter, the conference calling system performs response actions (340). For example, if the moderator ID and/or passcode was entered from the 410 area code, and the location parameter only includes the 202 and 571 area codes, then response actions are performed. In an alternative embodiment, the conference calling system determines whether the location where a participant passcode was entered matches the location parameter.

If all of the typical usage parameters are verified, the conference call is allowed to continue. In an alternative embodiment, the typical usage parameters are validated in another order, e.g., the location parameter is validated before the day of week parameter. In another alternative embodiment, the typical usage parameters are validated when a participant passcode is entered. For example, when a participant enters a passcode to access the teleconferencing system, the method determines whether the day of the week, time of day, and location where the participant's passcode was entered matches the typical usage parameters.

FIG. 4 is a flow diagram illustrating a method for performing response actions according to an embodiment of the invention. In alternative embodiments, one or more of the response actions illustrated in FIG. 4 are omitted, dependent on the configuration as determined in the preparation phase. As described below, in at least one embodiment, the response actions illustrated in FIG. 4 are performed by a processor connected to an electronic storage device and a receiver.

The processor requests additional moderator identification and/or credentials from the person who entered the moderator ID/passcode that violates a typical usage parameter (410). The moderator identification includes the moderator's corporate employee number and/or ID badge number. The credentials may include, for example, at least one of the moderator's home telephone number, home address, mobile telephone number, e-mail address, office telephone number, office address, and secret question(s) entered when the moderator was assigned the moderator passcode(s) (e.g, pet's name, date of birth, mother's maiden name).

The processor of the conference calling system determines whether the information entered by the person violating the typical usage parameters matches the actual moderator identification and/or credentials (412). In at least one embodiment, the actual moderator identification and/or credentials are obtained from the true moderator during the preparation phase. If the additional moderator identification and/or credentials are valid, then response actions are not performed. If the additional moderator identification and/or credentials are not valid, then the conference calling system determines whether to alert the conference system administrator (419).

If the conference system administrator is alerted by the processor (420), further actions are automatically or manually performed by the conference system administrator. In at least one embodiment of the invention, such actions are setup during the preparation phase. The conference system administrator actions include monitoring for additional occurrences where the typical usage parameters are violated, monitoring for occurrences where additional moderator identification and/or credentials are not valid, terminating the conference call, and/or blocking the account from further usage (i.e., voiding the moderator ID and/or passcode). For example, in at least one embodiment, a passcode is voided or temporarily disabled after 5 unsuccessful attempts to access the conference calling system in a 24 hour period.

The processor in at least one embodiment also determines whether to alert others (429) in addition or alternatively to the moderator and/or the person assigned the passcode. The processor alerts others (430) by sending an alert to at least one of the true moderator, administrative personnel of the conference calling system provider, and security personnel employed by the true moderator's company who is responsible for tracking risks and investigating fraud across the company. The alert indicates that the typical usage parameters have been violated. In at least one embodiment, the alerts include a time stamped e-mail, text message, instant message, facsimile, and/or other form of communication.

Furthermore, the processor determines whether to log information for future reference and reporting into, for example, a report database (439). The processor logs information (440) by saving a report of the occurrence (e.g., in an electronic database), wherein the report includes, for example, at least one of the typical usage parameters defined during the preparation phase, the typical usage parameters violated, the day of week that the moderator's ID and/or passcode was entered, the time of day that the moderator's ID and/or passcode was entered, the location where the moderator's ID and/or passcode was entered (telephone number, office building, area code, zip code, address, city, state, and/or time zone), the moderator's ID and/or passcode, additional moderator identification and/or credentials entered by the person requesting access to the conference calling system, the actual identification and/or credentials of the true moderator, the telephone numbers of the attendees that called into the conference calling system (obtained from a caller-identification system), and a detailed description of the response action(s) taken, e.g., time, date, and identification of persons who were sent an alert. In at least one embodiment, the conference system administrator compares reports that have been collected over time in order to identify trends, such as the number of times a particular attendee violates a typical usage parameter.

Whether or not information is logged, the processor disconnects the person violating the typical usage parameters from the conference calling system (450). In an alternative embodiment, the response actions illustrated in FIG. 4 are performed in another order, e.g., the person violating the typical usage parameters is disconnected from the conference calling system prior to requesting moderator identification and/or credentials. In another alternative embodiment, the processor performs other actions as determined by users of the conference calling system. For example, in at least one embodiment of the invention, the processor voids the passcode of an attendee if that attendee entered his or her passcode outside of the typical usage parameters. In another embodiment, the conference calling system automatically captures an audio recording of the conference call when a typical usage parameter is violated.

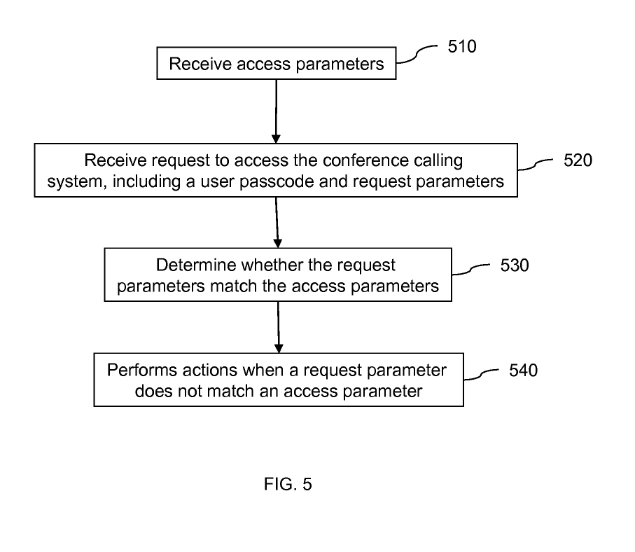

FIG. 5 is a flow diagram illustrating a method for detecting fraudulent use in a conference calling system according to an embodiment of the invention. One or more access parameters (also referred to herein as “typical usage parameters”) are received (510), wherein the access parameters include an authorized day of week parameter, an authorized time of day parameter, and/or an authorized location parameter. In at least one embodiment, a conference moderator defines the access parameters by calling the conference calling system and answering select configuration questions (e.g., via a telephone keypad) and/or configuration is completed via a website where the conference moderator enters the parameters (e.g., via drop-down menus).

The authorized day of week parameter indicates at least one day of the week where access to the conference calling system is authorized (e.g., Monday through Wednesday). The authorized time of day parameter indicates at least one time of day where access to the conference calling system is authorized (e.g., 10:00 am-11:00 am and 1:00 pm-3:00 pm); and, the authorized location parameter indicates at least one location where access to the conference calling system is authorized (e.g., 202 area code).

One or more requests to access the conference calling system are received (520), wherein each request includes a user passcode (e.g., moderator passcode or participant passcode) and one or more request parameters. The request parameters include a request day of week parameter indicating the day of the week that the request is received, a request time of day parameter indicating the time of day that the request is received, and/or a request location parameter indicating the location where the request is sent from.

A processor determines whether the request parameters match the access parameters (530). Access to the conference calling system is granted when the request parameters match the access parameters; however, the processor performs actions when a request parameter does not match an access parameter (540). In at least one embodiment, the actions include sending an alert indicating that a request parameter does not match an access parameter to an administrator of the conference calling system, the person who sent the request to access the conference calling system, participants of the conference call of the conference calling system, and/or security personnel of the teleconference provider and/or at least one company employing a participant of the teleconference call. If the conference system administrator is alerted by the processor, further actions are automatically or manually performed by the conference system administrator in at least one embodiment of the invention, wherein such actions are setup during the preparation phase.

At least one embodiment of the invention, user information (also referred to herein as “first information”) is obtained from the person assigned the user passcode violating the access parameter. In at least one embodiment, the user information is input into an electronic database by the system administrator, moderator, and/or another employee of the user's company, wherein the user information is subsequently retrieved from the database for validation purposes. The user information includes an employee number, an identification badge number, a home a telephone number, a home address, a mobile telephone number, an e-mail address, an office telephone number, an office address, and/or answer(s) to security question(s) entered by the person assigned the user passcode. In at least one embodiment, the user information is obtained from the authorized users of the conference calling system during the preparation phase.

Furthermore, the actions performed by the processor include obtaining validation information (also referred to herein as “second information”) from the person who sent the request violating the access parameter, and determining whether the validation information matches the user information. If the user information matches the validation information, an alert indicating that the request parameter does not match the access parameter is sent to the person who sent the request to access the conference calling system. If the user information does not match the validation information, actions are performed by the processor 640.

In at least one embodiment of the invention, the actions further include permitting an administrator of the conference calling system to enter the conference call, terminating the conference call, and/or voiding the user passcode. In another embodiment, the actions include generating and storing a report, where the report includes the user passcode violating the access parameter, the violated access parameter, the request parameter violating the access parameter, and/or the actions performed (e.g., including the user and validation information). In at least one embodiment, the conference system administrator compares reports that have been collected over time in order to identify trends, such as the number of times a particular attendee violates a typical usage parameter.

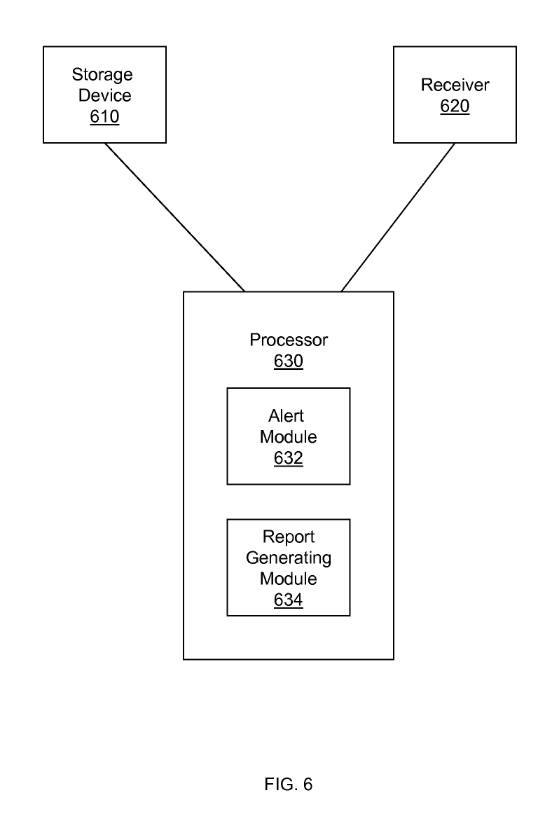

FIG. 6 illustrates a system for detecting fraudulent use in a conference calling system according to an embodiment of the invention. The system includes an electronic storage device 610 including at least one access parameter (e.g., a database including a list of typical usage parameters). The system further includes a receiver 620 for receiving a request to access the conference calling system, wherein the request includes a user passcode and/or one or more request parameters.

A processor 630 is operatively connected to the electronic storage device 610 and the receiver 620, wherein the processor 630 determines whether the request parameters match the access parameters. If a request parameter does not match an access parameter, the processor 630 performs actions, as more fully described above.

The processor 630 includes an alert module 632 for sending an alert indicating that a request parameter does not match an access parameter to an administrator of the conference calling system, the person who sent the request to access the conference calling system, participants of the conference call, and/or at least one security personnel. The processor 632 further includes a report generating module 634 for generating and storing a report. The report includes the user passcode violating the access parameter, the violated access parameter, the request parameter violating the access parameter, and the actions performed. In another embodiment, the alert module 632 and report generating module 634 are outside of the processor 630.

Accordingly, an embodiment of the invention includes systems and methodologies to investigate potential fraudulent activity on conference calling systems. The occurrence of a potential fraudulent condition is identified, such that rapid response actions may be taken. The embodiments of the invention can save thousands of dollars in fraudulent toll charges. Moreover, the ability to identify fraudulent activity can prevent or reduce the likelihood of unauthorized access to confidential information from a teleconference.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

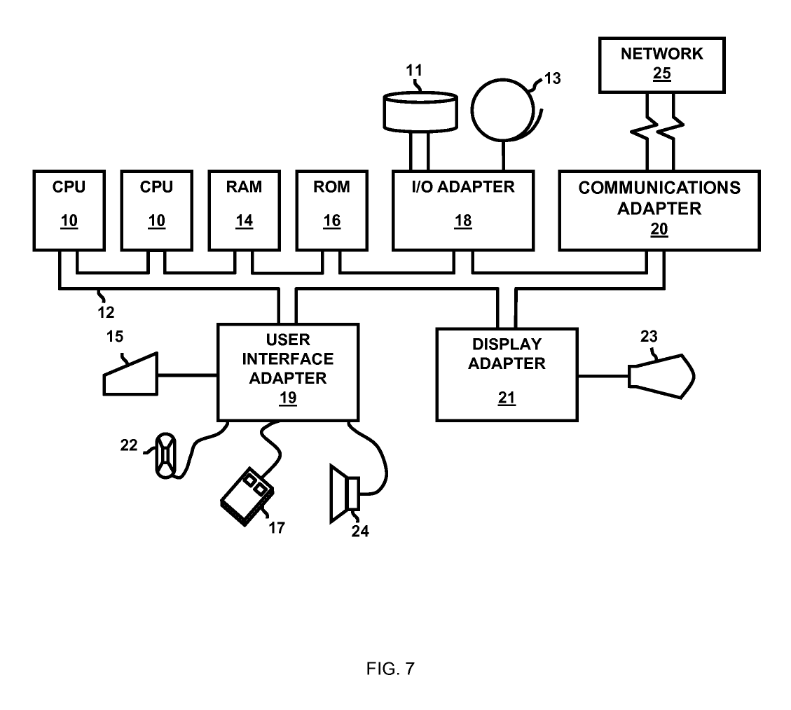

Referring now to FIG. 7, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for detecting fraudulent use in a conference calling system, said method including:
receiving at least one access parameter;
receiving a request to access the conference calling system, the request including at least one of a user passcode and at least one request parameter;
determining whether the request parameter matches the access parameter with a processor; and
performing actions with the processor when the request parameter does not match the access parameter.

2. The method according to claim 1, further including permitting access to the conference calling system when the request parameter matches the access parameter.

3. The method according to claim 1, wherein the access parameter includes an authorized day of week parameter, the authorized day of week parameter indicating at least one day of week where access to the conference calling system is authorized, and
wherein the request parameter includes a request day of week parameter, the request day of week parameter indicating a day of week that the request is received.

4. The method according to claim 1, wherein the access parameter includes an authorized time of day parameter, the authorized time of day parameter indicating at least one time of day where access to the conference calling system is authorized, and wherein the request parameter includes a request time of day parameter, the request time of day parameter indicating a time of day that the request is received.

5. The method according to claim 1, wherein the access parameter includes an authorized location parameter, the authorized location parameter indicating at least one location where access to the conference calling system is authorized, and wherein the request parameter includes a request location parameter, the request location parameter indicating a location where the request is sent from.

6. The method according to claim 1, further including obtaining first information from a person assigned the user passcode, wherein said performing of the actions includes
obtaining second information from a person who sent the request to access the conference call, and
determining whether the first information matches the second information.

7. The method according to claim 6, wherein said performing of the actions includes, sending an alert to the person who sent the request to access the conference calling system if the first information matches the second information, the alert indicating that the request parameter does not match the access parameter.

8. The method according to claim 6, wherein the first information includes at least one of an employee number, an identification badge number, a home a telephone number, a home address, a mobile telephone number, an e-mail address, an office telephone number, an office address, and at least one answer to at least one security question entered by the person assigned the user passcode.

9. The method according to claim 1, wherein said performing of the actions includes sending an alert to at least one of an administrator of the conference calling system, a person who sent the request to access the conference calling system, participants of a conference call of the conference calling system, and at least one security personnel, the alert indicating that the request parameter does not match the access parameter.

10. The method according to claim 1, wherein said performing of the actions includes at least one of permitting an administrator of the conference calling system to enter a conference call of the conference calling system, terminating the conference call, and voiding the user passcode.

11. The method according to claim 1, wherein said performing of the actions includes generating and storing a report, where the report includes at least one of the user passcode, the access parameter, the request parameter, and the actions performed.

12. The method according to claim 11, wherein the actions include first information from a person assigned the passcode, and second information from a person who sent the request to access the conference call.

13. A method for detecting fraudulent use in a conference calling system, said method including:
receiving at least one unauthorized access parameter;
receiving a request to access the conference calling system, the request including at least one of a user passcode and at least one request parameter;
determining whether the request parameter matches the unauthorized access parameter with a processor; and
performing at least one of validation actions and alert actions with the processor when the request parameter matches the unauthorized access parameter.

14. The method according to claim 13, wherein the unauthorized access parameter includes an unauthorized day of week parameter, the unauthorized day of week parameter indicating at least one day of week where access to the conference calling system is unauthorized, and wherein the request parameter includes a request day of week parameter, the request day of week parameter indicating a day of week that the request is received.

15. The method according to claim 13, wherein the unauthorized access parameter includes an unauthorized time of day parameter, the unauthorized time of day parameter indicating at least one time of day where access to the conference calling system is unauthorized, and wherein the request parameter includes a request time of day parameter, the request time of day parameter indicating a time of day that the request is received.

16. The method according to claim 13, wherein the unauthorized access parameter includes an unauthorized location parameter, the unauthorized location parameter indicating at least one location where access to the conference calling system is unauthorized, and wherein the request parameter includes a request location parameter, the request location parameter indicating a location where the request is sent from.

17. A system for detecting fraudulent use in a conference calling system, said system including:
an electronic storage device including at least one access parameter;
a receiver for receiving a request to access said conference calling system, the request including at least one of a user passcode and at least one request parameter; and
a processor operatively connected to said electronic storage device and said receiver,
said processor determines whether the request parameter matches the access parameter, and
said processor performs actions when the request parameter does not match the access parameter.

18. The system according to claim 17, wherein the access parameter includes an authorized day of week parameter, the authorized day of week parameter indicating at least one day of week where access to said conference calling system is authorized, and wherein the request parameter includes a request day of week parameter, the request day of week parameter indicating a day of week that the request is received.

19. The system according to claim 17, wherein the access parameter includes an authorized time of day parameter, the authorized time of day parameter indicating at least one time of day where access to said conference calling system is authorized, and wherein the request parameter includes a request time of day parameter, the request time of day parameter indicating a time of day that the request is received.

20. The system according to claim 17, wherein the access parameter includes an authorized location parameter, the authorized location parameter indicating at least one location where access to said conference calling system is authorized, and wherein the request parameter includes a request location parameter, the request location parameter indicating a location where the request is sent from.

21. The system according to claim 17, wherein said receiver receives first information from a person assigned the user passcode and second information from a person who sent the request to access the conference call, and wherein said processor determines whether the first information matches the second information.

22. The system according to claim 17, wherein said processor includes an alert module, said alert module sends an alert to at least one of an administrator of said conference calling system, a person who sent the request to access said conference calling system, participants of a conference call of said conference calling system, and at least one security personnel, the alert indicating that the request parameter does not match the access parameter.

23. The system according to claim 17, wherein said processor does at least one of permits an administrator of said conference calling system to enter a conference call of said conference calling system, terminates the conference call, and voids the user passcode.

24. The system according to claim 17, further including a report generating module for generating and storing a report, where the report includes at least one of the user passcode, the access parameter, the request parameter, and the actions performed.

25. A computer program product for detecting fraudulent use in a conference calling system, said computer program product including:
a computer readable storage medium;
first program instructions to receive at least one access parameter;
second program instructions to receive a request to access the conference calling system, the request including at least one of a user passcode and at least one request parameter;
third program instructions to determine whether the request parameter matches the access parameter with a processor; and
fourth program instructions to perform actions with the processor when the request parameter does not match the access parameter,
wherein said first program instructions, said second program instructions, said third program instructions, and said fourth program instructions are stored on said computer readable storage medium.
